(19) United States
(12) Patent Application Publication
(10) Pub. No.: US 2024/0236546 A9
(43) Pub. Date: Jul. 11, 2024

(54) ELECTRONIC DEVICE

(71) Applicant: AAC Microtech (Changzhou) Co., Ltd., Changzhou (CN)

(72) Inventors: Huhu Yang, Changzhou (CN); Zhaoyu Yin, Changzhou (CN); Zhizhu Chen, Changzhou (CN)

(21) Appl. No.: 18/337,407

(22) Filed: Jun. 19, 2023

Related U.S. Application Data
(63) Continuation of application No. PCT/CN2022/134562, filed on Nov. 28, 2022.

(30) Foreign Application Priority Data
Oct. 21, 2022 (CN) 202211295250.3

(51) Int. Cl. H04R 1/10; G10K 11/178; H04R 9/04; H04R 9/06

(52) U.S. Cl. CPC H04R 1/1075; G10K 11/17857; G10K 11/17873; H04R 9/046; H04R 9/063

(57) ABSTRACT

An electronic device includes an accommodation and a receiver. The accommodating piece defines a first cavity and a second cavity communicated with the first cavity. A first sounding hole and a second sounding hole communicated with outside are respectively defined on two opposite walls of the first cavity. The receiver is installed in the first cavity. The receiver includes a first diaphragm and a second diaphragm disposed opposite to first diaphragm. The first diaphragm faces the first sounding hole. The second diaphragm faces the second sounding hole. The first diaphragm vibrates to generate a first sound signal, the second diaphragm vibrates to generate a second sound signal, and a phase of the first sound signal is opposite to a phase of the second sound signal. Parts of sound signals generating sound leakage are compensated and counteracted through an algorithm, and a user has a good private call experience.

### TECHNICAL FIELD

The present disclosure relates to a field of electro-acoustic conversion, and in particularly to an electronic device.

### BACKGROUND

An electronic device, such as a mobile phone, a tablet, or the like, is served as an important experience terminal device in daily life, and people have higher and higher requirements on the electronic device, especially for sound performance of the electronic device. The electronic device comprises an earphone, a receiver, and a sound outlet hole. The receiver is configured to convert a received audio electrical signal into a sound signal and emits sound through the earphone and/or the sound outlet hole to outside, so that a user can hear the sound. The receiver comprises two mutually stacked receiver structures, and directions of diaphragms of the two stacked receiver structures are opposite. The receiver is placed in one of two cavities communicated with each other in the electronic device. Namely, the two receiver structures share one rear cavity. In the electronic device of the prior art, when the two receiver structures of the receiver share one rear cavity and when the electronic device plays sound, no matter whether the electronic device is in an earphone mode or in a loudspeaker mode, serious sound leakage occurs.

Therefore, it is necessary to provide an electronic device to solve above problems.

### SUMMARY

The present disclosure provides an electronic device that timely counteract sound signals generating sound leakage in an earphone mode to ensure privacy of a user during a call.

The technical solution of the present disclosure is as follows:

The present disclosure provides the electronic device. The electronic device comprises an accommodating piece and a receiver. A first cavity and a second cavity are defined in the accommodating piece. The first cavity is communicated with the second cavity. A first sounding hole and a second sounding hole are respectively defined on two opposite walls of the first cavity. The first sounding hole and the second sounding hole are communicated with outside.

The receiver is installed in the first cavity. The receiver comprises a first diaphragm and a second diaphragm. The first diaphragm is disposed opposite to the second diaphragm. The first diaphragm faces the first sounding hole, and the second diaphragm faces the second sounding hole.

The first diaphragm vibrates to generate a first sound signal. The second diaphragm vibrates to generate a second sound signal. A phase of the first sound signal is opposite to a phase of the second sound signal.

In one optional embodiment, along a thickness direction of the receiver, a projection of the first sounding hole completely coincides with a projection of the second sounding hole.

In one optional embodiment, a positioning frame is disposed in the accommodating piece. A first end of the positioning frame is connected to an inner wall of the accommodating piece. A second end of the positioning frame is extended along the accommodating piece to divide an interior of the accommodating piece into the first cavity and the second cavity communicated with the first cavity. A first positioning hole is defined on the positioning frame. The first positioning hole is communicated with the outside through the first sounding hole. A first end of the receiver is embedable in the first positioning hole. The first diaphragm is disposed on the first end of the receiver.

In one optional embodiment, a limiting step is disposed on an inner wall of the first positioning hole. In a process of embedding the receiver into the first positioning hole, the receiver abuts against the limiting step.

In one optional embodiment, the accommodating piece comprises a base, a first covering piece, and a second covering piece. The positioning frame is disposed in the base. The first covering piece covers an opening defined on one end of the base and is connected with the base. The first covering piece defines a second positioning hole. A second end of the receiver is embeddable into the second positioning hole. The second diaphragm is disposed on second end of the receiver. The second covering piece covers the first positioning hole and is connected with the first covering piece. The second sounding hole is defined on the second covering piece. The second positioning hole is connected with the outside through the second sounding hole.

In one optional embodiment, the accommodating piece further includes a supporting frame. A first end of the supporting frame is connected to a side, away from the base, of the first covering piece. A second end of the supporting frame is protruding in a direction away from the base. The second covering piece is connected with a first end, away from the first covering piece, of the supporting frame. A hollow portion of the supporting frame and the second positioning hole are oppositely disposed.

In one optional embodiment, the receiver comprises a first receiver structure, a second receiver structure, and a partition plate. The first diaphragm is disposed on the first receiver structure. The second diaphragm is disposed on the second receiver structure. The first receiver structure, the partition plate, and the second receiver structure are sequentially stacked.

In one optional embodiment, the first sounding hole and/or the second sounding hole is a strip-shaped hole or a circular hole.

In one optional embodiment, a third cavity communicated with the first cavity is defined in the accommodating piece, and the first cavity is disposed between the second cavity and the third cavity.

In one optional embodiment, the first cavity comprises a first bottom wall. The second cavity comprises a second bottom wall. The third cavity comprises a third bottom wall. The first sounding hole is defined on the first bottom wall. A first end of the first bottom wall is connected with the second bottom wall, and a second end of the first bottom wall is bent towards the accommodating piece and is connected with the third bottom wall.

In the electronic device of the present disclosure, the accommodating piece comprises the first cavity and the second cavity communicated with the first cavity, and the receiver is installed in the first cavity, so that the first diaphragm and the second diaphragm of the receiver share the second cavity. Since the phase of the first sound signal generated by vibration of the first diaphragm is opposite to the phase of the second sound signal generated by vibration of the second diaphragm, the two sound signals are counteracted in a transmission process, so that a private call function of the electronic device in the earphone mode is achieved, and sound leakage is prevented. Furthermore, the first sounding hole and the second sounding hole are respectively defined on the two opposite walls of the first cavity. The first diaphragm faces the first sounding hole, and the second diaphragm faces the second sounding hole, so that it is convenient to calculate how the second diaphragm generates the second sound signal having the phase opposite to the phase of the first sound signal on a basis that the first diaphragm vibrates to generate the first sound signal, and it is convenient to calculate how the first diaphragm generates the first sound signal having the phase opposite to the phase of second sound signal on a basis that the second diaphragm vibrates to generate the second sound signal. Namely, parts of the sound signals generating sound leakage are compensated and counteracted through an algorithm. Since the parts of sound signals generating the sound leakage are counteracted in time, a user has a good private call experience.

### DESCRIPTION OF DRAWINGS

FIG. 1 is a structural schematic diagram of an electronic device according to one embodiment of the present disclosure.

FIG. 2 is a cross-sectional schematic diagram taken along the line A-A shown in FIG. 1.

FIG. 3 is an exploded schematic diagram of the electronic device shown in FIG. 1.

FIG. 4 is a structural schematic diagram of a base and a positioning frame shown in FIG. 1.

FIG. 5 is an exploded schematic diagram of a receiver shown in FIG. 1.

FIG. 6 is an exploded schematic diagram of a second receiver structure shown in FIG. 5.

In the drawings:
1—accommodating piece; 11—first cavity; 111—first sounding hole; 112—second sounding hole; 113—first bottom wall; 12—second cavity; 121—second bottom wall; 13—positioning frame; 131—first positioning hole; 132—limiting step; 14—base; 15—first covering piece; 151—second positioning hole; 16—second covering piece; 17—supporting frame; 18—third cavity; 181—third bottom wall;
2—receiver; 21—first receiver structure; 211—first diaphragm; 22—second receiver structure; 221—second diaphragm; 222—basin frame; 223—voice coil; 224—dome; 225—main magnetic steel; 226—auxiliary magnet steel; 227—main pole core; 228—auxiliary pole core; 23—partition plate.

### DETAILED DESCRIPTION OF PREFERRED EMBODIMENTS

The present disclosure is further described below in conjunction with the accompanying drawings and embodiments below.

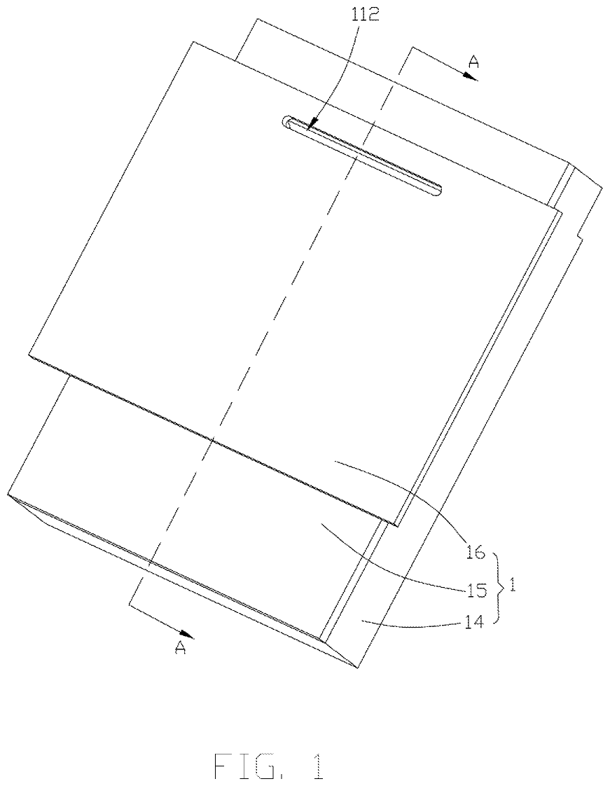

As shown in FIG. 1, the embodiment of the present disclosure provides an electronic device, such as a mobile phone, a tablet, or etc.

Specifically, the electronic device includes an accommodating piece 1 and a receiver 2. A first cavity 11 and a second cavity 12 are defined in the accommodating piece 1. The first cavity 11 is communicated with the second cavity 12. A first sounding hole 111 and a second sounding hole 112 are respectively defined on two opposite walls of the first cavity 11. The first sounding hole 111 and the second sounding hole 112 are communicated with outside. The receiver 2 is installed in the first cavity 11. The receiver 2 is comprises a first diaphragm 211 and a second diaphragm 221. The first diaphragm 211 is disposed opposite to the second diaphragm 221. The first diaphragm 211 faces the first sounding hole 111, and the second diaphragm 221 faces the second sounding hole 112. The first diaphragm 211 vibrates to generate a first sound signal. The second diaphragm 221 vibrates to generate a second sound signal. A phase of the first sound signal is opposite to a phase of the second sound signal.

The receiver 2 is an electroacoustic device capable of converting an audio electrical signal into a sound signal. When the receiver 2 works, the receiver 2 receives the audio electrical signal and further controls the first diaphragm 211 and/or the second diaphragm 221 to vibrate, so that sound waves are generated.

For one sound wave (i.e., a sound signal), a phase is a position (such as a peak, a trough, or a point between the peak and the trough) of the sound wave in its waveform at a certain moment. The phase may be considered to be a scale of the sound wave at the peak, the trough, or the point between the peak and the trough at the certain moment. The phase of the first sound signal is opposite to the phase of the second sound signal. For example, when the first sound signal is at the peak at the certain moment, the second sound signal is at the trough; and when the first sound signal is at the trough, the second sound signal is at the peak. Moreover, the first sound signal and the second sound signal are two sound waves with different sound sources. If parameters, such as amplitudes and frequencies, of the two sound waves at the same moment are same, the two sound waves are counteracted in a transmission process since the phase of the first sound signal is opposite to the phase pf the second sound signal.

The electronic device comprises an earphone mode, and one of the first sounding hole 111 and the second sounding hole 112 is an earphone or both of the first sounding hole 111 and the second sounding hole 112 are earphones. Taking the second sounding hole 112 is the earphone as an example, when the electronic device is in the earphone mode, the receiver 2 controls the second diaphragm 221 to vibrate, the second sound signal generated by vibration of the second diaphragm 221 is transmitted to the outside from the second sounding hole 112, and the user is able to put the second sounding hole 112 close to the ear to hear the sound. In the process, since the receiver 2 is installed in the first cavity 11, and the first cavity 11 is communicated with the second cavity 12, the second sound signal generated by the second diaphragm 221 is transmitted to the second cavity 12, and then a part of the second sound signal is transmitted from the second cavity 12 to the first sounding hole 111. At this time, the receiver 2 controls the first diaphragm 211 to vibrate, and the first diaphragm 211 vibrates to generate the first sound signal. The phase of the first sound signal is opposite to the phase of the second sound signal, so that the first sound signal and the part of the second sound signal are superposed and counteracted, thus preventing the second sound signal from transmitting to the outside from the first sounding hole 111. Therefore, the sound leakage is prevented. Similarly, when the first sounding hole 111 is the earphone, the first diaphragm 211 vibrates to generate the first sound signal. The first sound signal is transmitted to the outside from the first sounding hole 111, and a part of the first sound signal is transmitted to the second sounding hole 112. At this time, the second diaphragm 221 vibrates to generate the second sound signal. Since the phase of the second sound signal is opposite to the phase of the first sound signal, the second sound signal is superposed and counteracted with the part of the first sound signal, thus preventing the first sound signal from transmitting to the outside from the second sounding hole 112. Therefore, the sound leakage is prevented.

In the embodiment, the accommodating piece comprises the first cavity and the second cavity communicated with the first cavity and the receiver is installed in the first cavity, so that the first diaphragm and the second diaphragm of the receiver share the second cavity. Since the phase of the first sound signal generated by the vibration of the first diaphragm is opposite to the phase of the second sound signal generated by the vibration of the second diaphragm, the two sound signals are counteracted in a transmission process, so that a private call function of the electronic device in the earphone mode is achieved, and the sound leakage is prevented. Furthermore, the first sounding hole and the second sounding hole are respectively defined on the two opposite walls of the first cavity. The first diaphragm faces the first sounding hole, and the second diaphragm faces the second sounding hole, so that it is convenient to calculate how the second diaphragm generates the second sound signal having the phase opposite to the phase of the first sound signal on a basis that the first diaphragm vibrates to generate the first sound signal, and it is convenient to calculate how the first diaphragm generates the first sound signal having the phase opposite to the phase of second sound signal on a basis that the second diaphragm vibrates to generate the second sound signal. Namely, parts of the sound signals generating sound leakage are compensated and counteracted through an algorithm. Since the parts of sound signals generating sound leakage are counteracted in time, the user has a good private call experience.

In other embodiments, the first sounding hole 111 and the second sounding hole 112 may also be in other positions, as long as the phase of the first sound signal generated by the vibration of the first diaphragm 211 is opposite to the phase of the second sound signal generated by the vibration of the second diaphragm 212. In the embodiment, the first sounding hole 111 and the second sounding hole 112 are defined on the two opposite walls of the accommodating piece, so that the parts of the sound signals generating sound leakage are compensated and counteracted through the algorithm. Since the parts of sound signals generating sound leakage are counteracted in time, the user has a good private call experience.

In one specific embodiment, along a thickness direction H of the receiver 2, a projection of the first sounding hole 111 completely coincides with a projection of the second sounding hole 112. Namely, the first sounding hole 111 and the second sounding hole 112 are symmetrically disposed on the two opposite walls of the first cavity 11, so that the parts of sound signals generating sound leakage are counteracted in time.

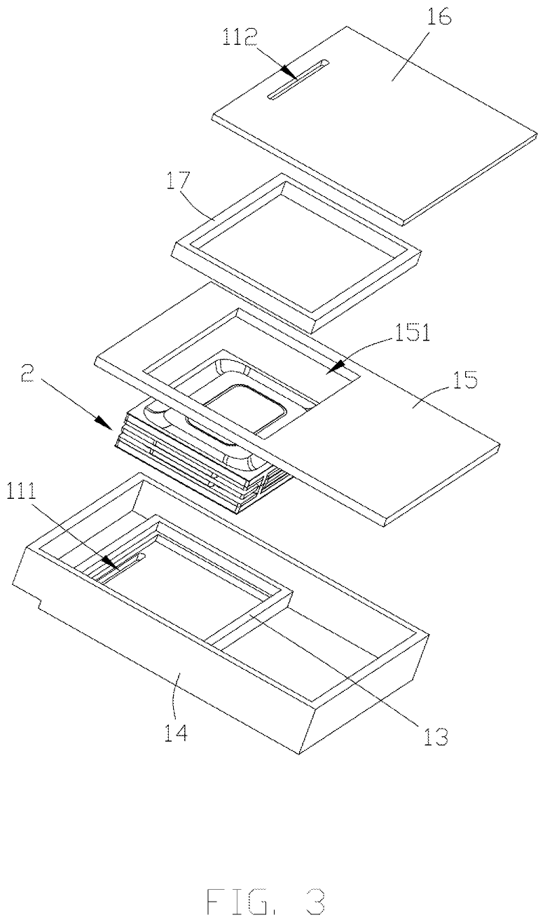

Specifically, the first sounding hole 111 and/or the second sounding hole 112 is a strip-shaped hole or a round hole. For example, both of the first sounding hole 111 and the second sounding hole 112 are strip-shaped holes as shown in FIG. 3. In other embodiments, the accommodating piece 1 may have a plurality of first sounding holes 111 and/or a plurality of second sounding holes 112. For example, the plurality of first sounding holes 111 are circular holes disposed side by side, and the plurality of second sounding holes 112 are circular hole disposed side by side.

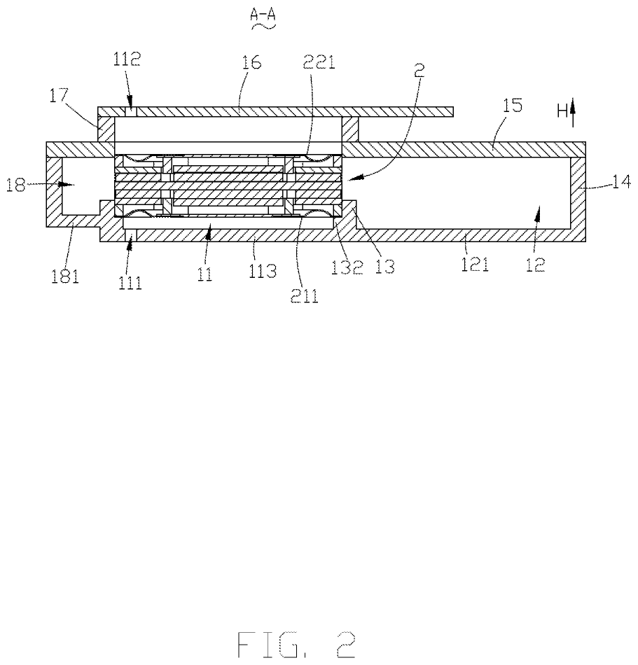

In one specific embodiment, as shown in FIG. 2-3, a positioning frame 13 is disposed in the accommodating piece 1. A first end of the positioning frame 13 is connected to an inner wall of the accommodating piece 1. A second end of the positioning frame 13 is extended along the accommodating piece 1 to divide an interior of the accommodating piece into the first cavity 11 and the second cavity 12 communicated with the first cavity. A first positioning hole 131 is defined on the positioning frame 13. The first positioning hole 131 is communicated with the outside through the first sounding hole 111. A first end of the receiver 2 is embeddable in the first positioning hole 131. The first diaphragm 211 is disposed on the first end of the receiver 2.

By arrangement of the positioning frame 13, when the receiver 2 is installed in the accommodating piece 1, the first end of the receiver 2 is embedded in the first locating hole 131, so that the first diaphragm 211 faces the first sounding hole 111, thereby facilitating the installing of the receiver 2.

Specifically, along the thickness direction H of the accommodating piece 1, the projection of the first sounding hole 111 is within the projection of the first positioning hole 131. In this way, when the first end of the receiver 2 is embedded in the first positioning hole 131, a portion of the first diaphragm 211 is disposed opposite to the first sounding hole 111, so that the sound wave generated by the vibration of the first diaphragm 211 is transmitted to the outside from the first sounding hole 111.

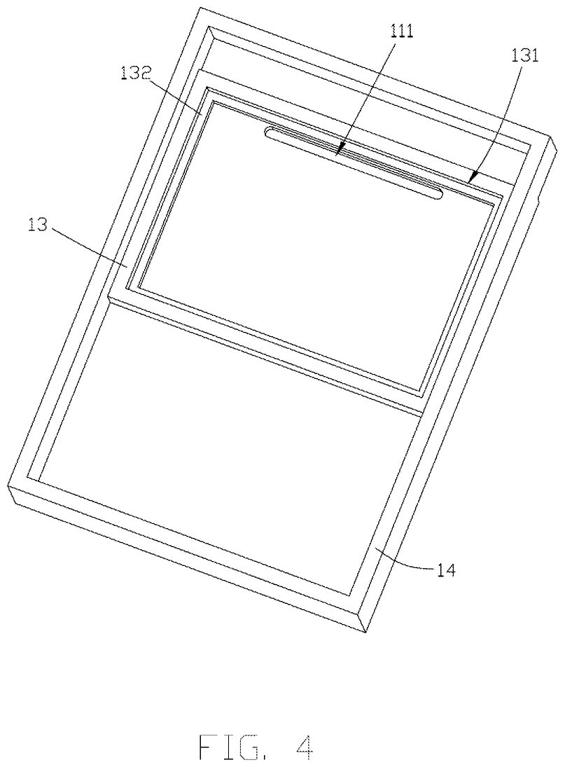

Furthermore, as shown in FIG. 2-4, a limiting step 132 is arranged on an inner wall of the first positioning hole 131. In a process of embedding the receiver 2 into the first positioning hole 131, the receiver 2 abuts against the limiting step 132.

After the receiver 2 is installed in place, there is a certain distance between the first diaphragm 211 and the first sounding hole 111, which provides a suitable space for the first diaphragm 211 to vibrate, and is convenient for the first diaphragm 211 to couple with air to generate the sound wave.

Furthermore, as shown in FIG. 3, the accommodating piece 1 includes a base 14, a first covering piece 15, and a second covering piece 16. The positioning frame 13 is disposed in the base 14. The first covering piece 15 covers an opening defined on one end of the base 14 and is connected with the base 14. The first covering piece 15 defines a second positioning hole 151. A second end of the receiver 2 is embeddable into the second positioning hole 151. The second diaphragm 221 is disposed on second end of the receiver 2. The second covering piece 16 covers the first positioning hole 131 and is connected with the first covering piece 15. The second sounding hole 112 is defined on the second covering piece 16. The second positioning hole 151 is connected with the outside through the second sounding hole 112.

When assembling the receiver 2, a first end of the receiver 2 is installed in the first positioning hole 131 of the positioning frame 13. Then, the second positioning hole 151 of the first covering piece 15 is aligned with the second end of the receiver 2. Then the second positioning hole 151 is embedded in an outer side of the second end of the receiver 2. At this time, a rest portion of the first covering piece 15 covers the opening on one end of the base 14 and is connected with the base 14. Finally, the second sounding hole 112 of the second covering piece 16 is aligned with the second positioning hole 151, and a rest portion of the second covering piece 16 covers the second positioning hole 151 and is connected with the first covering piece 15. At this time, the first diaphragm 211 faces the first sounding hole 111, and the second diaphragm 221 faces the sounding hole 112.

The base 14 is a battery cover of the mobile phone, the tablet computer, etc. The first covering piece 15 is a covering plate. The second covering piece 16 is a display screen. The display screen defines the second sounding hole 112. The second sounding hole 112 is the earphone. The battery cover defines the first sounding hole 111, and the first sounding hole 111 is a sound outlet hole.

In addition, the base 14 and a supporting frame 17 are integrally formed.

In another embodiment, the accommodating piece 1 includes a main frame, a third covering piece, and a fourth covering piece (not shown in the figures). The third covering piece and the fourth covering piece respectively cover on two sides of the main frame in a thickness direction of the main frame. The first sounding hole 111 is defined on the third covering piece, and the second sounding hole 112 is defined on the fourth covering piece.

The third covering piece and the fourth covering piece are display screens, and the first sounding hole 111 and the second sounding hole 112 are earphones, so that the two sides of the electronic device in the thickness direction realize the private call function of the earphones.

Specifically, as shown in FIG. 2-3, the accommodating piece 1 further includes the supporting frame 17. A first end of the supporting frame 17 is connected to one side, away from the base 14, of the first covering piece 15. A second end of the supporting frame 17 is extended in a direction away from the base 14. The second covering piece 16 is connected with the second end of the supporting frame 17. A hollow portion of the supporting frame 17 is opposite to the second positioning hole 151.

In the embodiment, the supporting frame 17 is installed on the first covering piece 15. The second covering piece 16 is connected with the second end of the supporting frame 17, which improves installation stability of the second covering piece 16. Further, by such arrangement, the supporting frame 17 is installed by a tool without reducing an installation precision of the supporting frame 17, which further reduces costs.

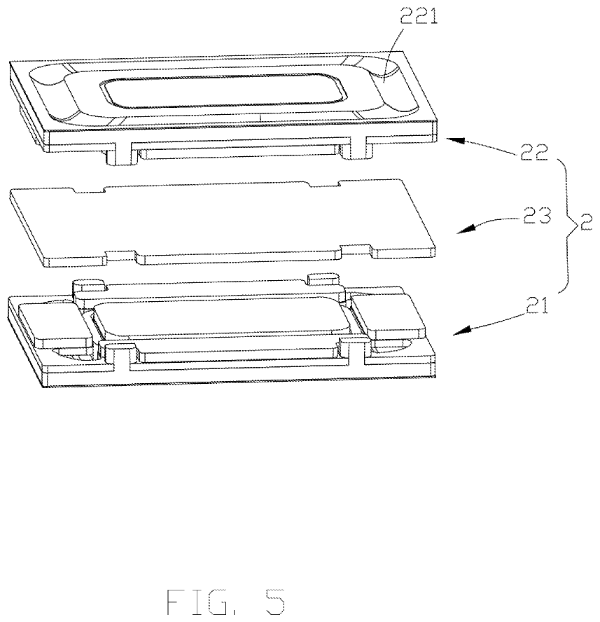

In one specific embodiment, as shown in FIG. 5, the receiver 2 includes a first receiver structure 21, a second receiver structure 22, and a partition plate 23. The first diaphragm 211 is disposed on the first receiver structure 21. The second diaphragm 221 is disposed on the second receiver structure 22. The first receiver structure 21, the partition plate 23, and the second receiver structure 22 are sequentially stacked.

When the receiver 2 works, the first receiver structure 21 is independently controlled to work. Namely, the first diaphragm 211 is controlled to vibrate. Alternatively, the second receiver structure 22 is independently controlled to work. Namely, the second diaphragm 221 is controlled to vibrate. Alternatively, the first receiver structure 21 and the second receiver structure 22 are controlled to work simultaneously. Namely, the first diaphragm 211 and the second diaphragm 221 is controlled to vibrate at the same time.

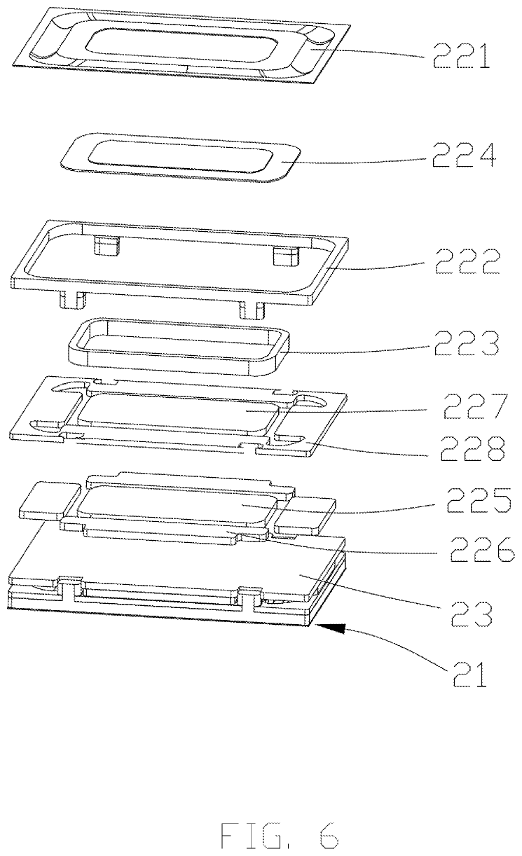

The partition plate 23 is disposed between the first receiver structure 21 and the second receiver structure 22 and plays a role in separating a first magnetic circuit system of the first receiver structure 21 from a second magnetic circuit system of the second receiver structure 22. As shown in FIG. 6, a specific structure of the second receiver structure 22 is described in detail. Specifically, the second receiver structure 22 includes a basin frame 222, a second vibration system fixedly disposed on the basin frame 222, and the second magnetic circuit system fixedly disposed on the basin frame 222. The second vibration system includes a second diaphragm 221, a voice coil 223 and a dome 224. The voice coil 223 is disposed below the second diaphragm 221 and is configured to drive the second diaphragm 221 to vibrate and produce sound. The dome 224 is disposed below the second diaphragm 221 and is configured to reinforce the vibration of the second diaphragm 221. The second magnetic circuit system includes main magnetic steel 225 and auxiliary magnetic steels 226 disposed around the main magnetic steel 225. A magnetic gap is defined between the main magnetic steel 225 and the auxiliary magnetic steels 226, and the voice coil 223 is inserted into the magnetic gap. The second magnetic circuit system further includes a main pole core 227 attached to the surface of the main magnetic steel 225 facing the second diaphragm 221 and an auxiliary pole core 228 attached to surfaces of the auxiliary magnetic steels 226 facing the second diaphragm 221

Specifically, a structure of the first receiver structure 21 may be same as a structure of the second receiver structure 22.

In one specific embodiment, as shown in FIG. 2, a third cavity 18 communicated with the first cavity 11 is defined in the accommodating piece 1, and the first cavity 11 is defined between the second cavity 12 and the third cavity 18.

Specifically, as shown in FIG. 2, the first cavity 11 comprises a first bottom wall 113. The second cavity 12 comprises a second bottom wall 121. The third cavity 18 comprises a third bottom wall 181. The first sounding hole 111 is defined on the first bottom wall 113. A first end of the first bottom wall 113 is connected with the second bottom wall 121, and a second end of the first bottom wall 113 is bent towards the accommodating piece 1 and is connected with the third bottom wall 181. The first bottom wall 113 is flush with the second bottom wall 121.

The above is only an embodiment of the present disclosure, and it should be noted that, for a person of ordinary skill in the art, improvement can be made without departing from the concept of the present disclosure, but these are all within the protection scope of the present disclosure.

What is claimed is:

1. An electronic device, comprising:
an accommodating piece (1), and
a receiver (2);
wherein a first cavity (11) and a second cavity (12) are defined in the accommodating piece (1); the first cavity (11) is communicated with the second cavity (12); a first sounding hole (111) and a second sounding hole (112) are respectively defined on two opposite walls of the first cavity (11); the first sounding hole (111) and the second sounding hole (112) are communicated with outside;
wherein the receiver (2) is installed in the first cavity (11); the receiver (2) comprises a first diaphragm (211) and a second diaphragm (221); the first diaphragm (211) is disposed opposite to the second diaphragm (221); the first diaphragm (211) faces the first sounding hole; the second diaphragm (221) faces the second sounding hole (112);
wherein the first diaphragm (211) vibrates to generate a first sound signal; the second diaphragm (221) vibrates to generate a second sound signal; a phase of the first sound signal is opposite to a phase of the second sound signal.

2. The electronic device according to claim 1, wherein along a thickness direction (H) of the receiver (2); a projection of the first sounding hole (111) completely coincides with a projection of the second sounding hole (112).

3. The electronic device according to claim 1, wherein a positioning frame (13) is disposed in the accommodating piece (1); a first end of the positioning frame (13) is connected to an inner wall of the accommodating piece (1); a second end of the positioning frame (13) is extended along the accommodating piece (1) to divide an interior of the accommodating piece (1) into the first cavity (11) and the second cavity (12) communicated with the first cavity; and
a first positioning hole (131) is defined on the positioning frame (13); the first positioning hole (131) is communicated with the outside through the first sounding hole (111); a first end of the receiver (2) is embeddable in the first positioning hole (131); the first diaphragm (211) is disposed on the first end of the receiver (2).

4. The electronic device according to claim 3, wherein a limiting step (132) is disposed on an inner wall of the first positioning hole (131); in a process of embedding the receiver (2) into the first positioning hole (131), the receiver (2) abuts against the limiting step (132).

5. The electronic device according to claim 3, wherein the accommodating piece (1) comprises a base (14), a first covering piece (15), and a second covering piece (16); the positioning frame (13) is disposed in the base (14); the first covering piece (15) covers an opening defined on one end of the base (14) and is connected with the base (14); the first covering piece (15) defines a second positioning hole (151); a second end of the receiver (2) is embeddable into the second positioning hole (151); the second diaphragm (221) is disposed on second end of the receiver (2); the second covering piece (16) covers the first positioning hole (131) and is connected with the first covering piece (15); the second sounding hole (112) is defined on the second covering piece (16); the second positioning hole (151) is connected with the outside through the second sounding hole (112).

6. The electronic device according to claim 5, wherein the accommodating piece (1) further comprises a supporting frame (17); a first end of the supporting frame (17) is connected to one side, away from the base (14), of the first covering piece (15); a second end of the supporting frame (17) is extended in a direction away from the base (14); the second covering piece (16) is connected with the second end, away from the first covering piece (15), of the supporting frame (17); a hollow portion of the supporting frame (17) is opposite to the second positioning hole (151).

7. The electronic device according to claim 1, wherein the receiver (2) comprises a first receiver structure (21), a second receiver structure (22), and a partition plate (23); the first diaphragm (211) is disposed on the first receiver structure (21); the second diaphragm is disposed on the second receiver structure (22); the first receiver structure (21), the partition plate (23), and the second receiver structure (22) are sequentially stacked.

8. The electronic device according to claim 1, wherein the first sounding hole (111) and/or the second sounding hole (112) is a strip-shaped hole or a circular hole.

9. The electronic device according to claim 1, wherein a third cavity (18) communicated with the first cavity (11) is defined in the accommodating piece (1), and the first cavity (11) is disposed between the second cavity (12) and the third cavity (18).

10. The electronic device according to claim 9, wherein the first cavity (11) comprises a first bottom wall (113); the second cavity (12) comprises a second bottom wall (121); the third cavity (18) comprises a third bottom wall (181); the first sounding hole (111) is defined on the first bottom wall (113); a first end of the first bottom wall (113) is connected with the second bottom wall (121); a second end of the first bottom wall (113) is bent towards the accommodating piece (1) and is connected with the third bottom wall (181).
